(19) United States
(12) Patent Application Publication
(10) Pub. No.: US 2009/0323825 A1
(43) Pub. Date: Dec. 31, 2009

(54) Processing of Sub-Sampled Images

(76) Inventor: Arthur Mitchell, Wincheater (GB)

Correspondence Address: COATS & BENNETT, PLLC, 1400 Crescent Green, Suite 300, Cary, NC, 27518, US

(21) Appl. No.: 12/513,931

(22) PCT Filed: Nov. 9, 2007
(86) PCT No.: PCT/GB07/04296

§ 371 Date: Aug. 12, 2009

(30) Foreign Application Priority Data
Nov. 10, 2006 (GB) 0622487.7

(51) Int. Cl. H04N 7/26

(52) U.S. Cl. 375/240.26; 375/E07.2

(57) ABSTRACT

A method and apparatus for estimating a previously encoding resolution to provide an estimated resolution; and using the estimated resolution to down-sample the compressed video signal to the estimated previously encoded resolution for processing the video signal.

This invention relates to processing of sub-sampled images.

Image compression systems are now well established in the delivery and storage of audiovisual media. These systems reduce bandwidth or storage requirements of video by exploiting spatial and temporal redundancy in an image by means of mathematical transforms such as Fourier, discrete cosine and entropy coding to minimise a number of symbols needed to represent the image in a compressed domain.

One issue with broadcast feeds is that although there are coding and interface standards that define a nominal horizontal image resolution, in practice an image is frequently encoded in the compression domain with a horizontal resolution lower than this nominal standard. This is done as a bit-saving measure as a reduced horizontal resolution contains less information to be encoded. When video signals processed in this way are decompressed and restored to an uncompressed format they are typically passed via equipment interfaces for further processing, e.g. within a studio, which necessitates the restoration of the standard resolution by means of up-sampling. As a result this signal may subsequently be mistaken for a full standard resolution signal when in fact it is not, having been reduced in horizontal resolution in an upstream system. The fact that this has been done upstream is not normally communicated by any widely known means to a receiving process downstream. The effect of such a practice is unnecessarily to degrade image quality. It is an object of this invention to avoid such degradations by taking account of any discernable upstream down-sampling.

When multiple stages of compression and decoding occur it is often a requirement that the image be processed in some fashion before a next encoding stage. This processing could take many forms such as reduction of noise, reduction of compression artefacts or the gathering of statistics from the video image to direct a next compression stage.

Since horizontal sub-sampling before compression affects both frequency information in the image as well as artefacts produced by compression, operations on an image must cope with all possible scenarios, often requiring further calculations involved or compromising results obtained.

It is an object of the present invention at least to ameliorate the aforesaid disadvantages in the prior art.

According to the invention there is provided an apparatus comprising programmable down-sampling means arranged to receive a video signal; and previously encoded resolution estimator means arranged to provide an estimate of an encoding resolution of the received video signal to the down-sampling means for down-sampling the video signal for subsequent processing of the video signal at a down-sampled resolution.

Advantageously, the apparatus further comprises up-sampling means arranged to receive the estimate from the previously encoded resolution estimator means and to up-sample the video signal after the subsequent processing.

Conveniently, the apparatus further comprises transform function means for transforming the video signal to a transfer domain before down-sampling.

Preferably, the apparatus is arranged to input an output of the transform function means to the programmable down-sampler means and to the previously encoded resolution estimator means.

According to a second aspect of the invention there is provided a method of processing a compressed video signal comprising the steps of: estimating a previously encoding resolution to provide an estimated resolution; and using the estimated resolution to down-sample the compressed video signal to the estimated previously encoded resolution for processing the video signal.

Conveniently, the method further comprises using the estimated resolution to up-sampling the video signal subsequent to the processing.

Advantageously, the method further comprises performing a transform function on the signal prior to down-sampling the video signal so that the video signal is down-sampled in a transform domain.

Conveniently, the method further comprises using the video signal in the transform domain to estimate the previously encoding resolution.

According to a third aspect of the invention, there is provided a computer program product comprising code means for performing all the steps of the method described above when the program is run on one or more computers.

According to a fourth aspect of the invention, there is provided computer program product as described above embodied by a computer storage medium.

The invention will now be described, by way of example, with reference to the accompanying drawings in which:

FIG. 1 is a schematic diagram of a system according to the invention;

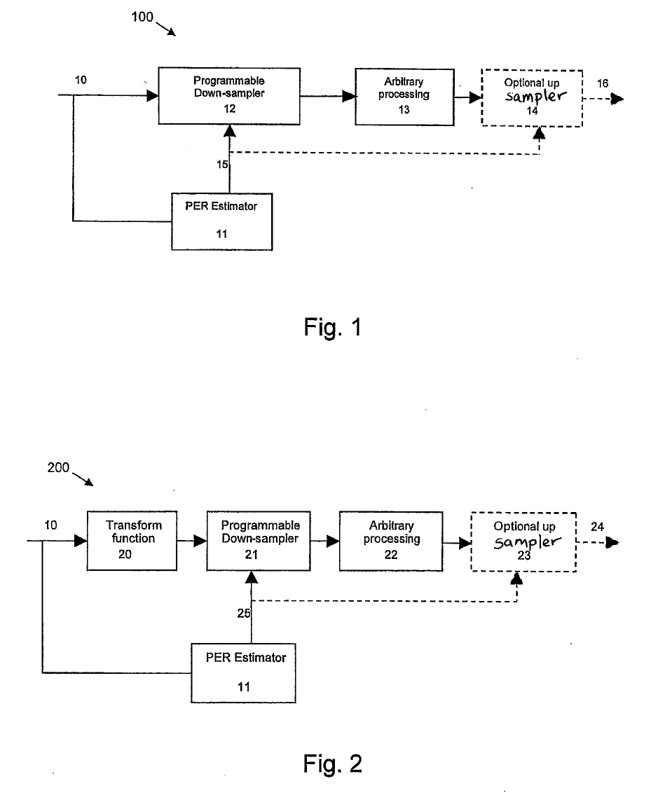

FIG. 2 is a schematic diagram of a transform domain video processing system according to the invention;

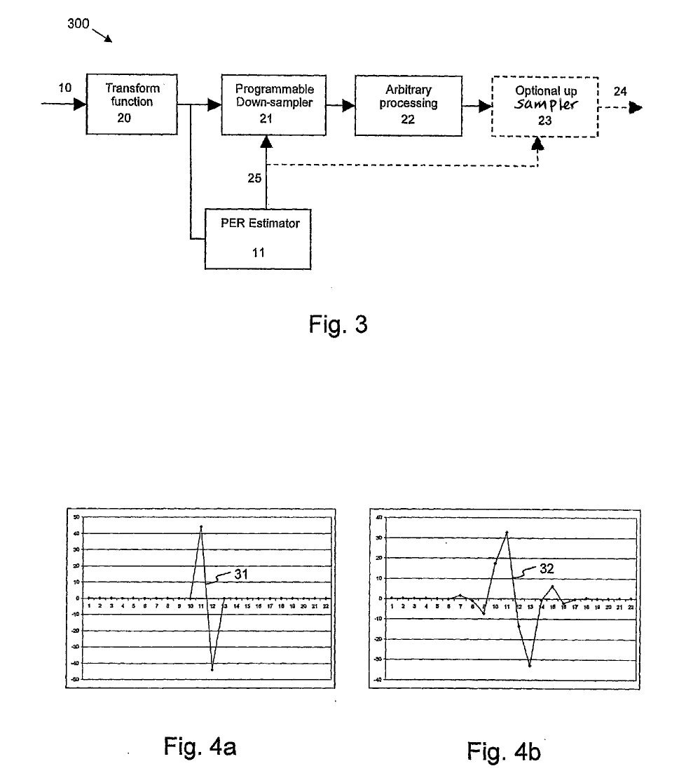

FIG. 3 is a schematic diagram of a transform domain video processing system according to the invention with an optimised use of a transform domain in PER estimation;

FIG. 4a is a graph representing an ideal edge in the transform domain; and

FIG. 4b is a graph representing an up-sampled edge;

In the Figures, like reference numbers denote like parts.

Referring to FIG. 1 a video processing system 100 according to the invention includes a programmable down sampler 12 having a video signal input 10 and an output to a processing module 13. Any process may be performed by the processing module 13 since the actual process performed is not relevant to the working of the invention. The processing module 13 may have an output to an optional up-sampler 14 with an output 16. The video signal is also input to a previously encoded resolution estimator 11 which has an output 15 to a second input of the programmable down sampler 12 and, if present, to a second input of the optional up-sampler 14.

An incoming image at the video input 10 is examined by the previous encoded resolution (PER) detector 11. The video signal at the video input 10 is normally formatted in a standard manner such that a decompression process restores a full nominal standard resolution for interface purposes, not the down-sampled resolution made by filtering in an up-stream compression coder. This loss of resolution, once made up-stream, can never be recovered and thus propagates a degraded signal through a down-stream video transmission chain. The previous encoded resolution detector 11 makes an estimate of the previous encoded resolution and generates a control signal 15 to control the programmable down sampler 12. The programmable down sampler 12 performs a horizontal down sample on the image before the processing module 13 operates on the image. This ensures that, once in a reduced resolution form, the artefacts of up-sampling and subsequent repeated down-sampling do not unnecessarily further degrade image quality.

An optional up-sampling stage 14 after the image processing stage 13 may provide a horizontal up-sampled signal 16 of the image back to the full display resolution. This may or may not form part of a desired processing function.

It may be required that the image be processed in some transformed domain, such as frequency filtering, frequency decomposition or Laplacian transforms. In each case there may be a saving in calculations or improvement in results or performance when working at a lower resolution provided by the down-sampler 12.

FIG. 2 shows a second embodiment 200 of the invention which is similar to the first embodiment illustrated in FIG. 1, but in which the programmable down-sampler 21 is preceded by a transform function module 20 so that a video signal input 10 is to the transform function module 20 and, in parallel thereto, to the previously encoded resolution estimator 11. An output of the transform function module 20 is to an input of the programmable down-sampler 21.

A video signal at the video input 10 is first transformed by the transform module 20 and the transform signal down-sampled by the programmable down-sampler 21, controlled by a control signal 25 from the previously encoded resolution estimator 11 before passing through the processing/analysing process 22.

A further optimisation, illustrated in embodiment 300 in FIG. 3, uses data in the transform domain from the transform function module 20 to assist in the estimation of the PER. This is possible only if the transform function 20 is compatible with, or an intrinsic part of, the PER estimator 11. Thus in the embodiment of FIG. 3 a video signal at a video input 10 to the transform function module 20 is transformed to the transform domain before being input in parallel to the previously encoded resolution estimator 11 and the programmable sampler 21. Otherwise, the embodiment 300 is the same as the embodiment 200 shown in FIG. 2.

It should be noted that in a real-world system there may be times when the PER of the encoded image is the same as the full display resolution because there has been no up-stream down-sampling. In this case the down and up-sample elements 21, 23 pass the image or transform data, as the case may be, unchanged.

Referring to FIGS. 3 and 4, one application of the invention is a method of concealing block edge artefacts. These edges form a discontinuity of level in both luminance and chrominance domains and are an unwanted side effect of block-based spatial compression. Most algorithms for concealing block edges pre-calculate a position of the edges based on a defined rectangular grid that marks multiples of the compression block size. When a sub-sampled image is applied to this system the position of the block edges changes as do their characteristics.

FIGS. 4a and 4b show examples of the transform domain with, then without, the invention, respectively. This demonstrates an application of system 300 of FIG. 3 where the transform function 20 is a Laplacian of Gaussian (LoG) convolution and the input image contains a step function characteristic of a block edge artefact. The graphical representation of FIG. 4b shows the transform domain signal without the proposed system and has an irregular, elongated structure caused by a filtering process that performs up-stream down-sampling. The graphical representation of FIG. 4b shows a sub-sampled transform domain and a bi-polar pulse that is characteristic of the LoG function and can be clearly identified. Had there been no up-stream down-sampling and consequent loss of horizontal resolution this ideal pulse shape would be retained. Processing the transform domain signal results in a saving of calculation logic or comparison steps.

The invention thus provides improved performance by minimising calculation effort and variation in performance caused by the use of horizontal sub-sampling.

1-10. (canceled)

11. An apparatus comprising:
a programmable down-sampler configured to receive a video signal; and
a previously encoded resolution estimator configured to provide an estimate of an encoding resolution of the received video signal to the down-sampler for down-sampling the video signal for subsequent processing of the video signal at a down-sampled resolution.

12. The apparatus of claim 11 further comprising an up-sampler configured to receive the estimate from the previously encoded resolution estimator, and to up-sample the video signal after the subsequent processing of the video signal.

13. The apparatus of claim 11 further comprising a transform function configured to transform the video signal to a transfer domain before down-sampling is performed.

14. The apparatus of claim 13 wherein the apparatus is configured to input an output of the transform function to the programmable down-sampler, and to the previously encoded resolution estimator.

15. A method of processing a compressed video signal comprising the steps of:
estimating a previously encoded resolution of a compressed video signal to provide an estimated resolution; and
using the estimated resolution to down-sample the compressed video signal to the estimated previously encoded resolution for processing the video signal.

16. The method of claim 15 further comprising using the estimated resolution to up-sample the video signal subsequent to the processing of the video signal.

17. The method of claim 15 further comprising performing a transform function on the video signal prior to down-sampling the video signal so that the video signal is down-sampled in a transform domain.

18. The method of claim 17 further comprising using the video signal in the transform domain to estimate the previously encoded resolution.

19. A computer program product comprising program code configured to cause one or more computers executing the code to:
estimate a previously encoded resolution of a compressed video signal to provide an estimated resolution; and
use the estimated resolution to down-sample the compressed video signal to the estimated previously encoded resolution for processing the video signal.

20. The computer program product of claim 19 wherein the program code is further configured to cause the one or more computers to use the estimated resolution to up-sample the video signal subsequent to the processing of the video signal.

21. The computer program product of claim 20 wherein the program code is further configured to cause the one or more computers to perform a transform function on the video signal prior to down-sampling the video signal so that the video signal is down-sampled in a transform domain.

22. The computer program product of claim 20 wherein the program code is further configured to cause the one or more computers to use the video signal in the transform domain to estimate the previously encoded resolution.

23. The computer program product of claim 19 wherein the program code is stored on a computer storage medium.
